(19) United States
(12) Patent Application Publication
(10) Pub. No.: US 2023/0238912 A1
(43) Pub. Date: Jul. 27, 2023

(54) CENTRALIZED SOLAR TABLE ASSEMBLY

(71) Applicant: Terabase Energy, Inc., Berkeley, CA (US)

(72) Inventors: Matthew Campbell, Berkeley, CA (US); Brian Coleman, Portland, OR (US); Johann Fritz Karkheck, Petaluma, CA (US); Adam Hansel, Davis, CA (US); Soren Jensen, Corte Madera, CA (US)

(73) Assignee: Terabase Energy, Inc., Berkeley, CA (US)

(21) Appl. No.: 17/581,873

(22) Filed: Jan. 22, 2022

(51) Int. Cl. H02S 10/40

(52) U.S. Cl. CPC H02S 10/40

(57) ABSTRACT

A solar table assembly unit is described that facilitates assembly of a plurality of solar tables in a location remote from a plurality of installation points within a solar system. The assembly unit comprises at least one vertical support structures that is coupled to a central support structure, an upper rail and a lower rail. The central support structure supports a torque tube having a plurality of coupling points. The upper and lower rails allow movement of solar components, such as solar panels, relative to the coupling points. Assembled solar tables may be moved to a mobile transport for subsequent delivery to installation points within the solar system.

### TECHNICAL FIELD

The present disclosure relates generally to a centralized solar table assembly unit and system. More particularly, the present disclosure relates to a centralized solar table assembly unit that enables the assembly of solar tables in a location remote to installation points within a solar system and facilitates loading of the assembled solar panels to a mobile transport for subsequent delivery to corresponding installation points.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the cost-effective management of the construction process and the ability to efficiently assemble and install solar tables within the system.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliable and cost-effective installation of processes of solar tables at each location point. In prior art systems, the assembly of solar tables is performed at each installation point within the system. This distributed installation process requires the movement of materials and resources across large areas of the construction site to a large number of installation points. These issues further contribute to an increase in the cost and complexity of what is already a very cost-sensitive process.

FIG. 1 illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled and installed for a neighboring solar table within the system. While this approach may be effectively deployed in the installation of smaller solar systems, it becomes cost prohibitive as the size of the system increases.

What is needed are systems, devices and methods that reduce the complexity and cost of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a prior art assembly and installation process of large-scale solar panel systems.

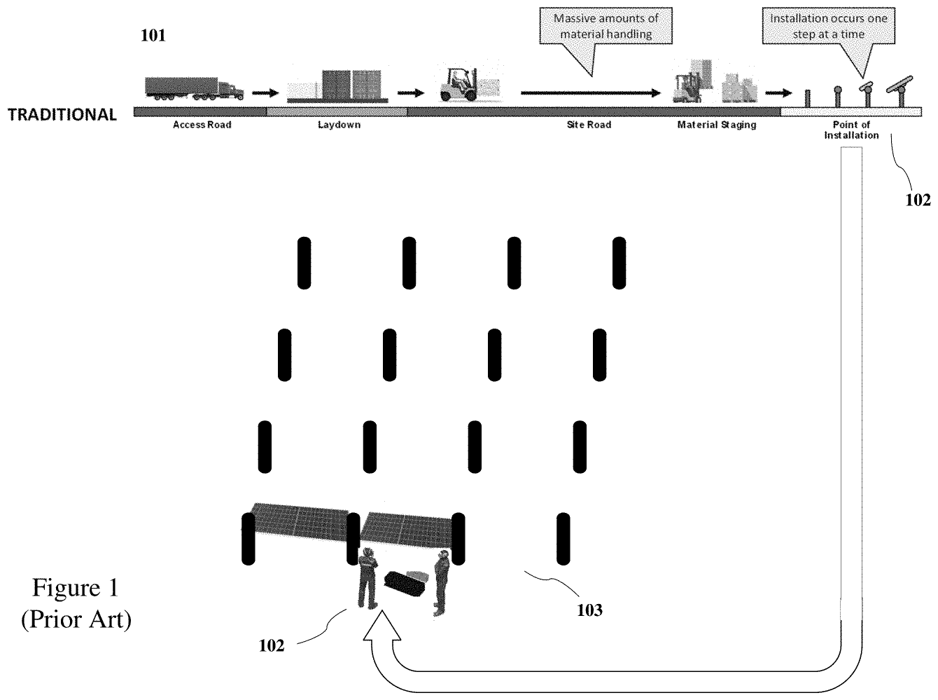

FIG. 2 is a diagram showing a centralized assembly and installation of a solar system including mobile transport of solar tables in accordance with various embodiments of the invention.

FIG. 3 is an exemplary overhead view of a solar table assembly unit according to various embodiments of the invention.

FIG. 4 is an overhead view of a solar table assembly unit showing multiple solar panels on rails during assembly according to various embodiments of the invention.

FIG. 5 is an overhead view of a solar table assembly unit showing an assembled solar table according to various embodiments of the present invention.

FIG. 6 is a back view of a solar table assembly unit according to various embodiments of the present invention.

FIG. 7 is a side view of a solar table assembly unit according to various embodiments of the invention.

FIG. 8 is a focused view of a bearing housing assembly on a torque tube of solar table positioned within a solar table assembly unit according to various embodiments of the invention.

FIG. 9 is a focused view of an end portion of an upper rail and a safety latch according to various embodiments of the invention

FIG. 10 illustrates a solar table assembly unit and mobile transport according to various embodiments of the invention.

FIG. 11 illustrates a first step in a process of positioning an assembled solar table from a solar table assembly unit to a mobile transport according to various embodiments of the invention.

FIG. 12 illustrates a second step in a process of positioning an assembled solar table from a solar table assembly unit to a mobile transport according to various embodiments of the invention.

FIG. 13 illustrates a third step in a process of positioning an assembled solar table from a solar table assembly unit to a mobile transport according to various embodiments of the invention.

FIG. 14 illustrates a fourth step in a process of positioning an assembled solar table from a solar table assembly unit to a mobile transport according to various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures are not intended to be limited to direct connections. Rather, data between these components may be modified, re-formatted, or otherwise changed by intermediary components. Also, components may be integrated together or be discrete prior to construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and assembly processes are difficult to manage. Additionally, embodiments of a solar table assembly unit may be implemented in smaller construction sites.

In this document, “large-scale solar system” refers to a solar system having 1000 or more solar panels. The word “resources” refers to material, parts, components, equipment or any other items used to construct a solar table and/or solar system. The term “solar table” refers to a structural assembly comprising a torque tube and/or purlins with (1) module rails coupled to modules or (2) modules being attached to the purlins. Some types of solar tables may have supplemental structure that allows it to connect to foundations/piles while other types do not have this supplemental structure. A solar table may have (but is not required) solar panels and/or electrical harnesses. The term “solar table assembly unit” (hereinafter, “assembly unit”) describes a device that supports assembly of solar tables in a location remote from an installation point within the solar system. The solar table assembly unit may be positioned in a variety of locations relative to installation points and allows an assembled solar table to be positioned on a mobile transport for subsequent delivery to a preferred installation point. The term “rail” refers to a support structure within the assembly unit that physically supports at least a portion of a solar table and facilitates movement of the solar table or components of a solar table during an assembly process. The term “solar panel” should be construed in its broadest sense and includes a variety of different components including a PV module or any other component used to facilitate or generate electrical current from sunlight.

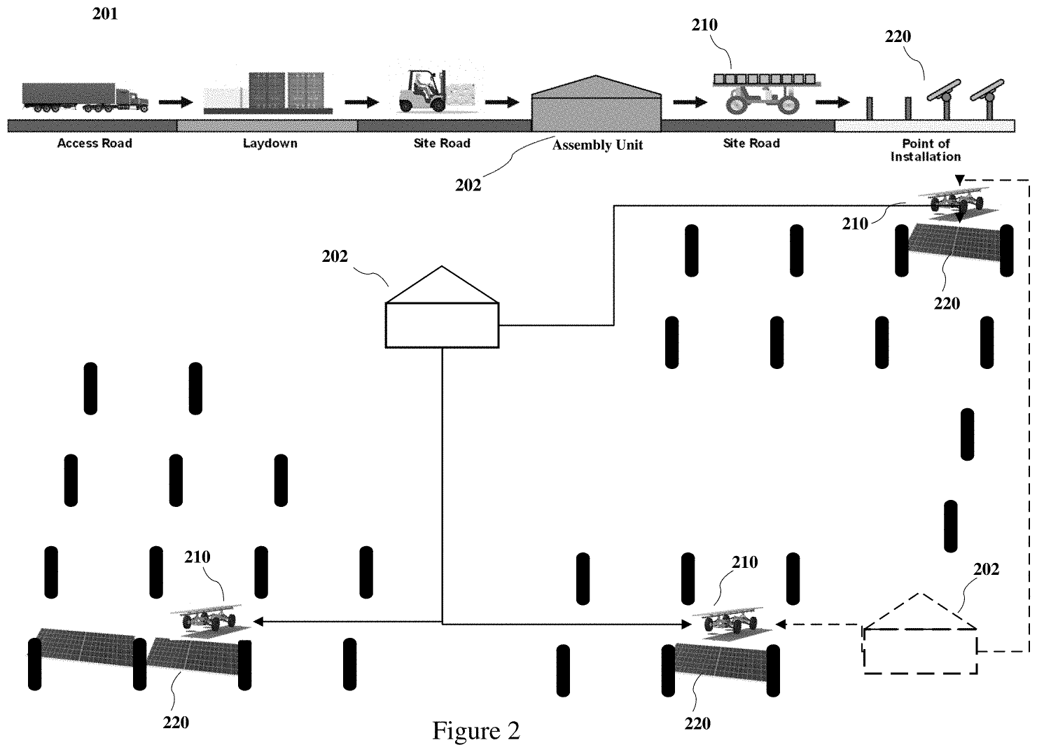

FIG. 2 provides an overview of centralized solar table assembly and subsequent installation within a large-scale solar system according to various embodiments of the invention. Embodiments of the invention transition the prior art approach of assembly and installation at single location sites to a centralized and coordinated assembly factory that allows a more cost-effective and dynamic process of constructing large-scale solar systems. This centralized assembly of solar system components, such as solar tables, necessitates a more robust assembly unit to allow assembly of solar tables remote from installation points and subsequent transportation of assembled solar tables to corresponding installation sites.

Resources are brought to a construction site 201 for a large-scale solar system and initially processed. These resources are delivered to one or more assembly units 202 where a coordinated and centralized solar table assembly process is performed. In certain embodiments, a construction site may have multiple centralized assembly units 202. As shown in FIG. 2, there are two assembly units 202 strategically located at the site. The location and number of assembly units 202 may depend on several parameters including the size of the site, the terrain of the site, the design of the site and other variables that relate to the construction of the large-scale solar system.

Assembled solar tables and equipment are moved from an assembly unit 202 to a point of installation 220 via motorized vehicles 210 such as a mobile transport. In certain embodiments, the mobile transports are specifically designed to transport solar tables along a site road to the point of installation 220. The mobile transports 210 may be driven by personnel, may be controlled by remote control, or autonomously driven by a computer system. The time and/or sequence in which solar tables are delivered to points of installation 220 may depend on a variety of factors that may be analyzed to configure a preferred schedule.

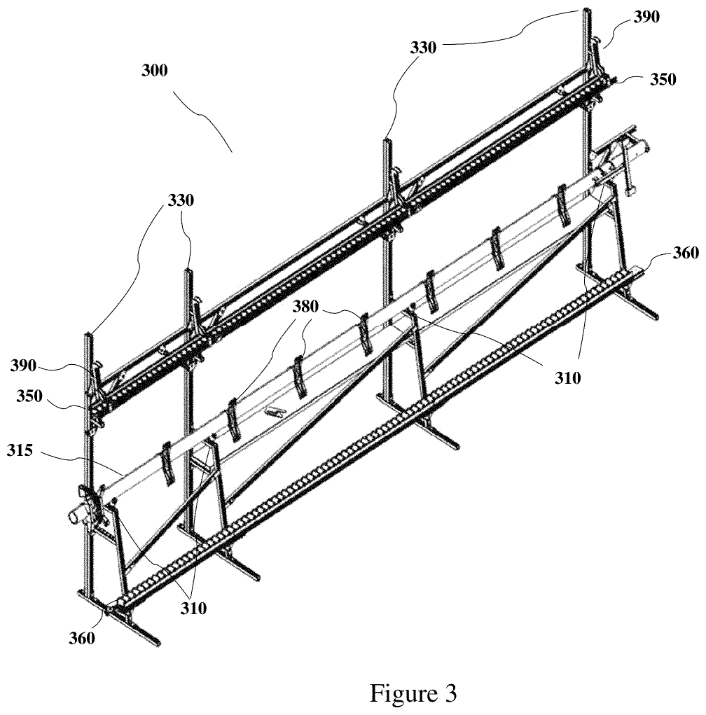

FIG. 3 illustrates a solar table assembly unit according to various embodiments of the invention. The assembly unit 300 may be located at various locations remote to multiple solar table installation sites and allows for the assembly of a plurality of solar tables for subsequent transportation to and integration at the installation sites. The assembly unit 300 comprises a central support structure 310 that supports a torque tube 315 of a solar table to be assembled. The central support structure 310 holds the torque tube 315 at a preferred vertical height and allows a user to rotate the tube while being supported. This central support structure 310 is located between an upper rail 350 and a lower rail 360 that support components, such as one or more solar panels, and allows movement of these components relative to the torque tube 315. The torque tube 315 comprises a plurality of coupling points 380 where solar components are secured to the torque tube 315. In certain instances, the torque tube 315 is first coupled to the assembly unit and solar panels are secured to the assembly unit thereafter. In other instances, one or more solar panels is secured to the torque tube 315 and placed in the assembly unit thereafter.

In other embodiments, the solar table is comprised of one or more purlins that are attached to one or more solar panels. In this instance, the central support structure 310 is modified to support the purlins instead of a torque tube.

In certain embodiments, the upper rail 350 and lower rail 360 support a plurality of solar panels and allow the solar panels to move within the assembly unit to preferred coupling points 380 at which they are coupled to the torque tube 315. The solar panels and/or torque tube may be pre-configured to support an attachment process such as having pre-drilled holes and/or brackets that allow bolts to secure a solar panel to the torque tube.

In one example, the upper rail 350 and lower rail 360 comprises movement elements, such as wheels or rotational balls, that allow a solar panel to horizontally slide across the assembly unit 300 for alignment to a preferred torque tube coupling point 380 at which the solar panel is secured to the torque tube 315. This movement may occur manually by an individual applying a horizontal force on a solar panel, by a robotic or automated process or a combination thereof. In one example, conveyer belts with or without cleats are used to place, space and move solar panels to a preferred location for assembly with the torque tube 315.

The assembly unit 300 further comprises a plurality of vertical support structures 330 that extend vertically from a base and supports the upper rail 350, the central support structure 310 and the lower rail 360. The assembly unit 300 may also comprise one or more safety latchs 390 that secure solar components (e.g. solar panels and/or solar tables) to a particular location(s) during or after assembly. For example, a safety latch 390 may prevent a solar panel from falling off the upper and lower rails. One skilled in the art will recognize that the assembly unit 300 may vary in size to support different sizes and shapes of solar components.

One skilled in the art will recognize the benefits, including assembly time and cost-savings, of using the assembly unit 300 to assemble solar tables at a centralized location and subsequently transport the assembled solar tables to installation points within solar system. Additionally, various embodiments of the assembly unit 300 may support the assembly of a solar table in a horizontal position instead of a vertical or near-vertical position. One skilled in the art will recognize that the positioning (horizontal, vertical or in-between) of the solar table within the assembly unit may be advantageous depending on the manner in which the solar table is assembled (manually assembled, automated, etc.) and the terrain/location at which the assembly process occurs.

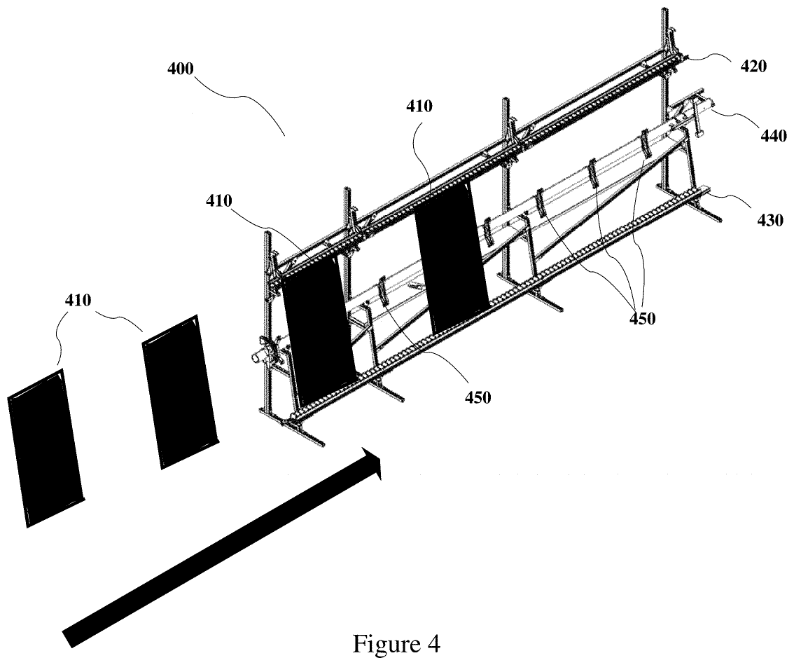

FIG. 4 illustrates an example of solar table assembly according to various embodiments of the invention. In this example, a solar table is assembled comprising a plurality of solar panels that are attached to a torque tube 440. Solar panels 410 are loaded onto the assembly unit 400 at a first side. Each solar panel 410 is supported by an upper rail 420 and a lower rail 430 that allow each solar panel to slide within the unit to a preferred torque tube coupling point 450 at which the solar panel is attached to the torque tube 440. In certain embodiments, an individual may position each of the solar tables by pushing on the table in a preferred direction and may use tools such as conveyers or rollers to assist in this process. Movement elements within the upper rail 420 and lower rail 430 provide a surface on which the solar panels slide.

One skilled in the art will recognize that the assembly unit 400 may be configurable to support a variety of different sizes and types of solar tables as well as facility solar table assembly with different numbers of solar panels assembled within a solar table.

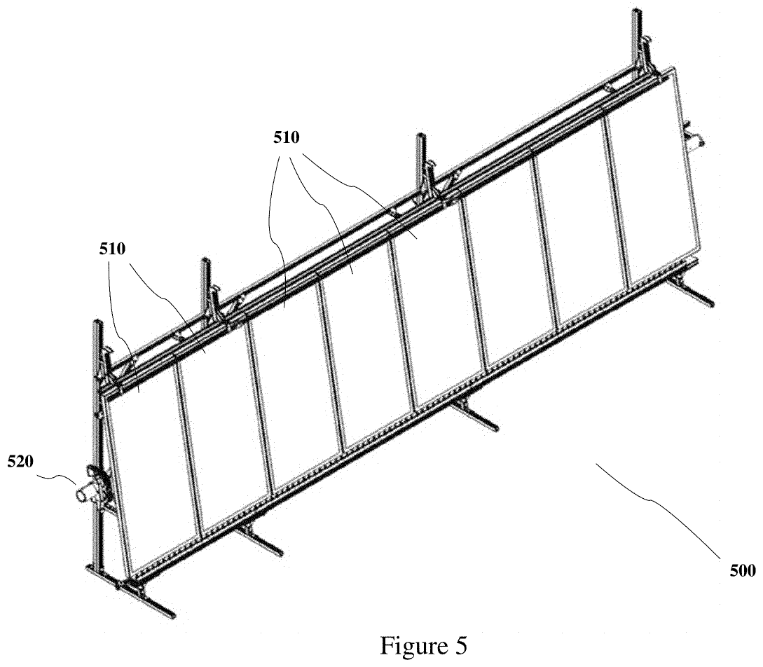

FIG. 5 illustrates an example of an assembled solar table according to various embodiments of the invention. As shown, a fully assembled solar table is shown comprising eight solar panels 510. Each of the solar panels 510 is attached to a torque tube 520 via torque tube coupling points (not visible). In certain embodiments, the assembly unit 500 provides post-assembly movement of a solar table for loading to a mobile transport that delivers the assembled solar table to an installation point. This loading process is described in more detail later in the specification.

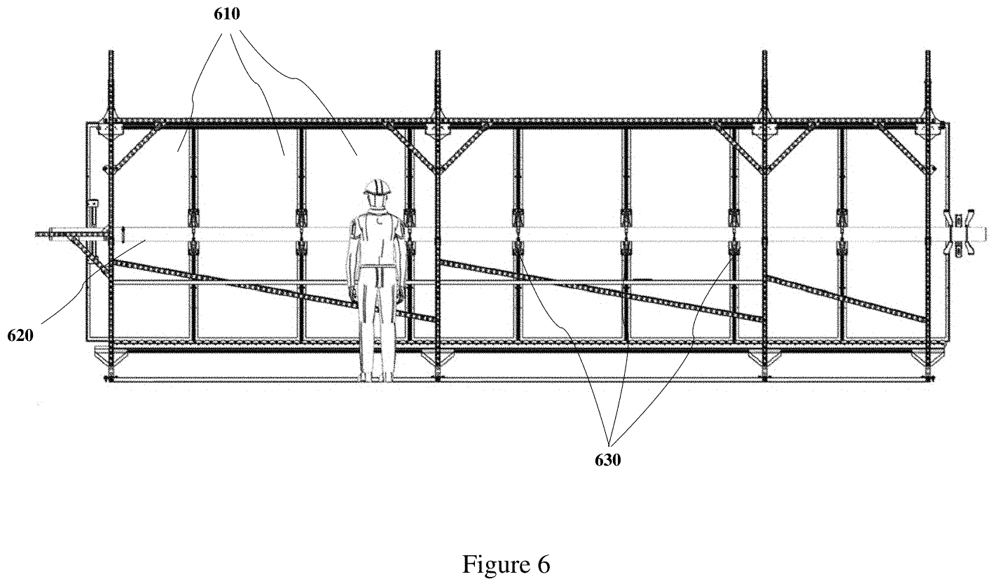

FIG. 6 shows a back-view of an assembled solar table within an assembly unit according to various embodiments of the invention. In this example, an assembly unit 600 has an assembled solar table comprising eight solar panels 610. Each of the solar panels 610 are attached to a torque tube 620 at one or more torque tube coupling points 630. One skilled in the art will recognize that a solar panel 610 may be attached to a torque tube 620 using a variety of components and methods. In one example, bracket elements are used to attach a solar panel 610 to the torque tube 620 by using screws/bolts. In embodiments, the assembly process may comprise a solar panel 610 being coupled to the torque tube 620 and/or an adjacent panel(s). The solar panels 610 may be pre-configured with attachment structures (such as drill holes) prior to the assembly process.

The assembly unit 600 provides space to allow an individual to access torque tube coupling points 630. In some embodiments, an individual(s) may first position a solar panel 610 at a preferred location within the assembly unit 600 and thereafter attach the solar panel 610 to the torque tube 620 and/or adjacent solar panel. In other embodiments, the attachment process is automated such that robotic functionality is provided within the assembly unit 600 that positions and attaches solar panels 610 within a solar table.

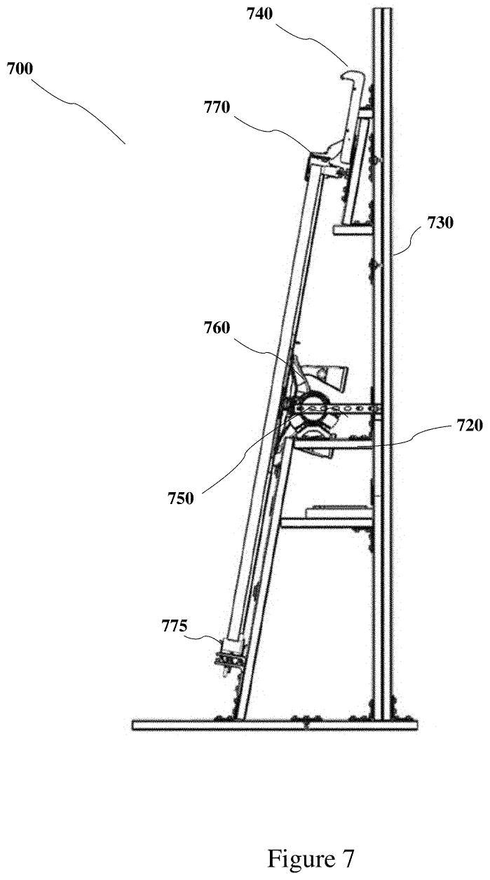

FIG. 7 illustrates a side view of an exemplary assembly unit according to various embodiments of the invention. As shown, the assembly unit 700 supports the assembly of a solar table 710 at a location remote from an installation point within a solar system. The assembly unit 700 comprises the central support structure 720 to which a torque tube 750 is attached. In this example, the solar panel is attached to the torque tube 750 via a C-shaped bracket 760. A vertical support structure 730 is shown that maintains the unit in an upright position. This vertical support 730 may be positioned within a wide vertical range such that it is at an angular position from the ground between 45 degrees and 135 degrees. An upper rail 770 and lower rail 775 are provided to support the solar table 710 and allow movement within the unit.

The assembly unit 700 further comprises a safety latch 740 that secures the solar table 710 within the unit itself. This safety latch 740 may secure the solar table 710 within a vertical or near-vertical plane while allowing movement along a horizontal plane. Embodiments of the invention may further provide the safety latch 740 to lock the solar table 710 into a position such that it is fixed along both horizontal and vertical planes. In this example, the safety latch 740 rotates to stabilize the solar table 710 or solar panel in place. The safety latch 740 may rotate to a first position that keeps the solar table 710 from falling off the upper and lower rails 770, 775 while still allowing the table to move horizontally along the rails. The safety latch 740 may rotate to a second position where it touches the solar table 710 and secures the table from both horizontal and vertical movement.

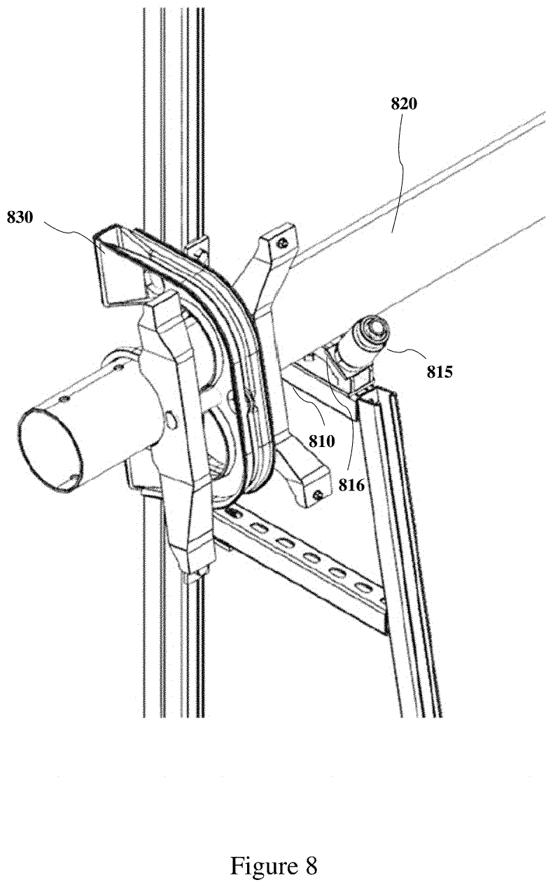

FIG. 8 illustrates a detailed illustration of an exemplary central support structure holding a torque tube according to various embodiments of the invention. A torque tube 820 is shown within an assembly unit 800 such that a torque tube end portion comprising a bearing housing assembly 830 rests upon the central support structure 810.

The central support structure 810 comprises an angled surface 816 on which the torque tube 820 rests and a support element 815 that holds the torque tube 820 in place. The angled surface 816 and support element 815 allow the tube 820 to be positioned within the assembly while still allowing movement and rotation. Accordingly, aligning solar panels to the torque tube at coupling points may be achieved by sliding the solar panels along the rails, moving the torque tube 820 along a horizontal plane or a combination thereof.

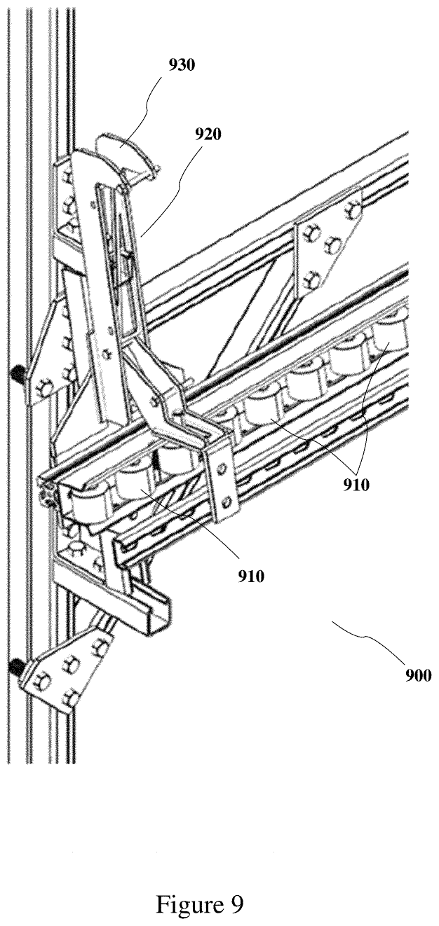

FIG. 9 illustrates an end portion of an upper rail and a safety latch according to various embodiments of the invention. In certain embodiments, the upper rail 900 comprises a plurality of wheels 910 (an example of movement elements) that allow solar panels to move horizontally within the assembly unit. A safety latch 920 is located proximate to the upper rail 900 to secure a solar panel or solar table within the assembly to avoid the table falling from the upper and lower rails.

In certain embodiments, the safety latch 920 rotates in a downward motion over a solar table or solar panel to secure the panel/table within the assembly unit. In some examples, the safety latch 920 comprises one or more edge extenders 930 that extend over the table/panel. If a deployed safety latch 920 has space between an edge extender 930, then the table/panel is secured within the assembly unit while allowing movement along a horizontal plane. If the edge extender 930 is fitted tightly to the table/panel, then the table/panel is secured in both vertical and horizontal directions.

One skilled in the art will recognize that the size and shape of a safety latch may vary across different embodiments of the invention. Additionally, edge extenders may not be present in certain examples of a safety latch.

As mentioned above, various embodiments of the assembly unit may provide structures and functions that allow an assembled solar table to be moved from the unit to a mobile transport for delivery to an installation point. This on-barding of assembled solar tables to a mobile transport may be performed manually, automated or a combination thereof. This combination of an assembly unit and a mobile transport allows for a more efficient and cost-effective process of constructing large-scale solar systems.

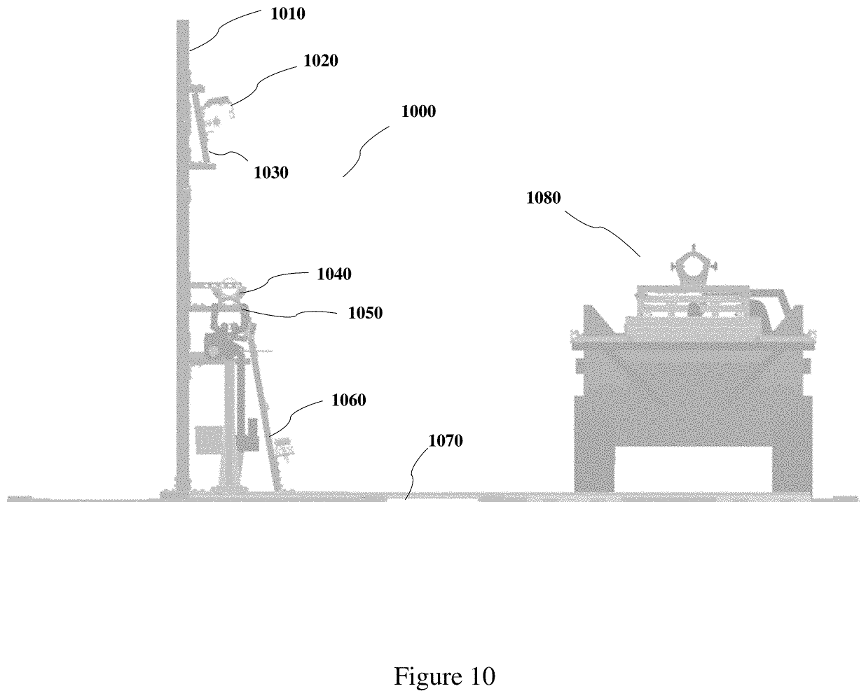

FIG. 10 illustrates an assembly unit and a mobile transport according to various embodiments of the invention. As shown, an assembly unit 1000 comprises vertical support structures 1010, central support structures 1050, upper rail 1030 and lower rail 1060. The assembly unit 1000 further comprise a safety latch 1020 that moves to secure a solar table within the assembly unit 1000. A solar table mobile portion 1060 is provided with a torque tube support device 1040 that holds a torque tube (and may also support an assembled solar table). In this example, the support device 1040 is a C-shaped holder in which the torque tube rests. One skilled in the art will recognize that the support device may have a variety of structures that support a torque tube/solar table.

In various embodiments, the solar table mobile portion 1060 is moveable along a track 1070 that facilitates movement of an assembled solar table from the assembly unit 1000 to a mobile transport 1080. This mobile portion 1060 and track 1070 provide structure that enables an individual or automated process to transition the solar table to the mobile transport 1080 for subsequent transportation to an installation point within the solar system. Other embodiments of the invention may not implement a track system between the assembly unit 1000 and the mobile transport 1080 and use another type of assembly structure such as an overhead gantry crane system.

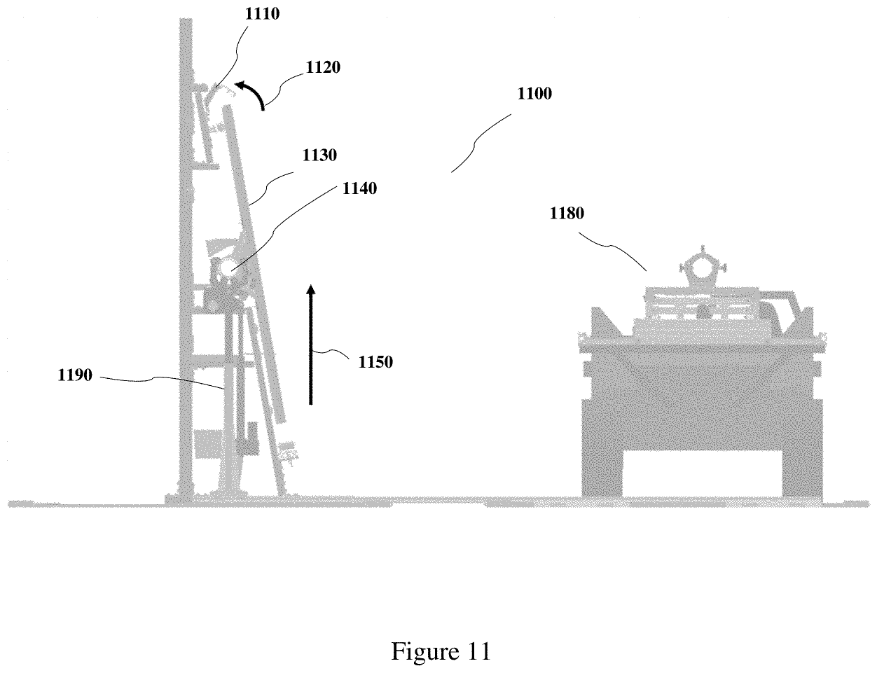

FIG. 11 illustrates a first step in a method of transitioning an assembled solar table from an assembly unit to a mobile transport according to various embodiments of the invention. In this example, an assembled solar table 1130 is completed and ready for transportation to an installation site. The safety latch 1110 is released by vertically rotating 1120 away from the solar table 1130 allowing movement away from the assembly unit 1100.

After the safety latch 1110 is released, the solar table may be moved vertically to create clearance between the torque tube 1140 and the support element 815 before transitioning away from the assembly station to provide clearance for rotation of the solar table. Thereafter, the solar table mobile portion (hereinafter, “mobile portion”) 1190 is rotatable 1150 around a central axis that allows a solar table to transition to a horizontal position. Once in this horizontal position, the mobile portion 1190 may be decoupled from the assembly unit 1100 to enable movement to a mobile transport 1180. One skilled in the art will recognize that a position of the solar table within the mobile portion 1190 may be modified based on implementations of various embodiments of the invention.

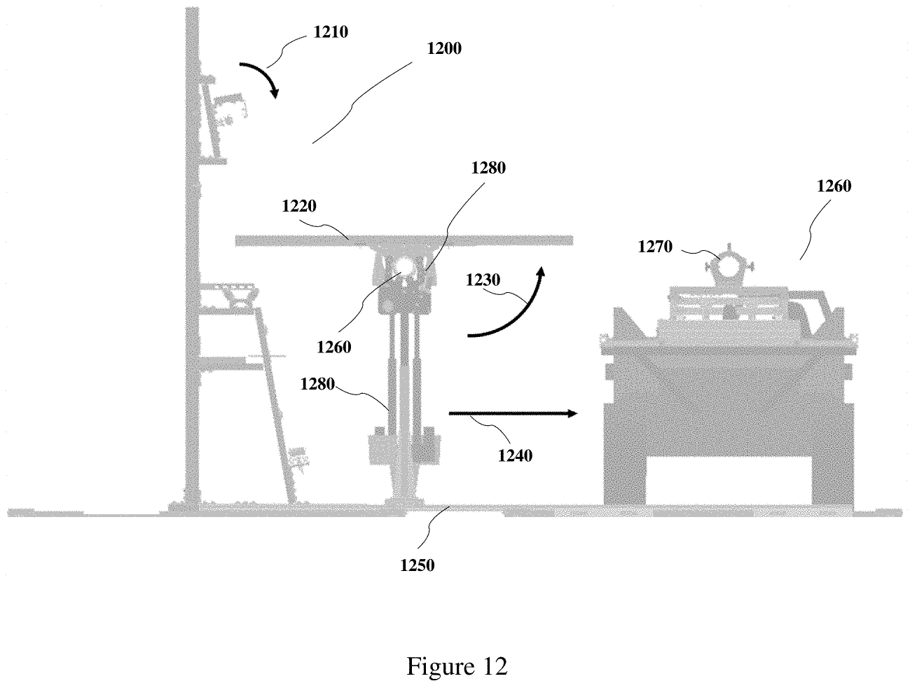

FIG. 12 illustrates a second step in a method of transitioning an assembled solar table from an assembly unit to a mobile transport according to various embodiments of the invention. In one example, the safety latch is released by rotation away from the solar panel which allows the solar panel to be lifted away from the assembly unit. The assembled solar table is moved horizontally 1240 to create clearance so that it may be rotated 1230 to a horizontal position. From this horizontal position, the assembled solar table may be moved to the mobile transport 1260 for subsequent delivery to an installation point.

After the solar table 1220 is decoupled the assembly unit 1200, the solar safety latch may be rotated 1210 back to a secure position so that a next assembly process may begin after the solar table 1220 is loaded onto a mobile transport 1260. In this example, the solar table 1220 is supported by having the torque tube 1260 resting within the support device 1280 (e.g., C-shaped holder) and is in a horizontal position. The solar table 1220 is still rotatable 1230 around a central axis (such as the torque tube 1260 residing within the support device 1280) to facilitate alignment to the mobile transport.

In various embodiments, the solar table 1220 is moved by the mobile portion 1280 along the track 1250 to the mobile transport 1260. The solar table 1220 is moved to a preferred position relative to the mobile transport for transition from the mobile portion 1280 to the mobile transport 1260. Embodiments of the invention allow a variety of methods and structures that facilitate the transition of the solar table to the mobile transport 1260. In this example, a solar table holder 1270 is located on the mobile transport 1260 to secure it during transportation to the installation point.

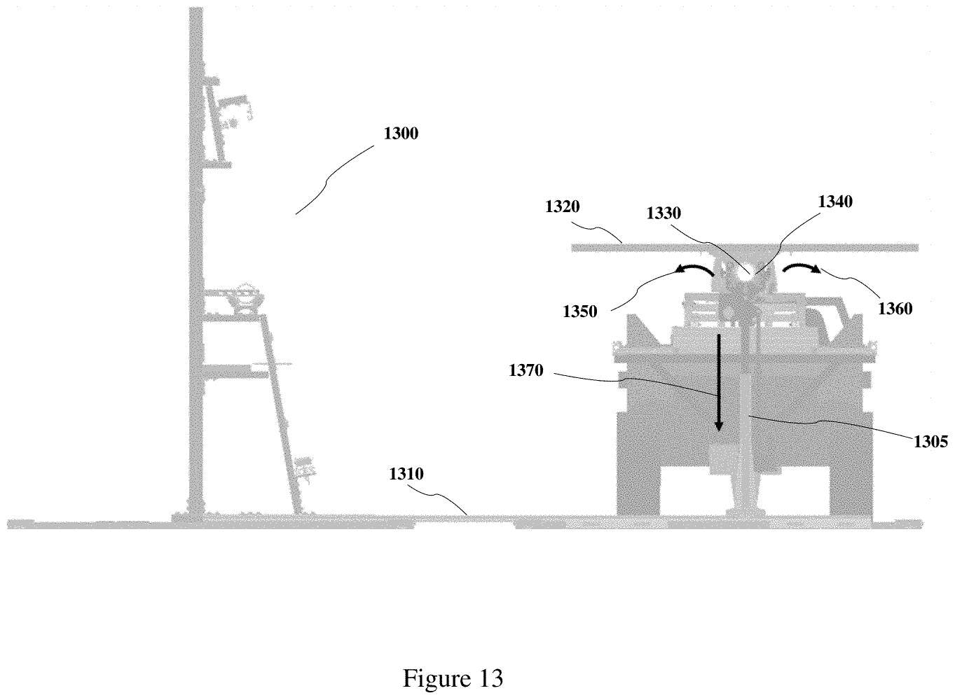

FIG. 13 illustrates a third step in a method of transitioning an assembled solar table from an assembly unit to a mobile transport according to various embodiments of the invention. As shown, the mobile portion 1305 of an assembly unit 1300 is positioned proximate to the mobile transport at a preferred location via track 1310. This preferred location facilitates transfer of the assembled solar table to the mobile transport. Embodiments of the invention support a variety of methods in which the solar table is aligned to the mobile transport to enable securing it to the mobile transport.

In one example, the mobile portion 1305 comprises a front vertical support and a back vertical support that are positioned at the front and back of the mobile transport and aligned to the solar table holder on the mobile transport. Once this alignment is complete, the solar table 1320 is lowered 1370 into position such that the torque tube 1330 is located within the solar table holder of the mobile transport. The support device 1340 on the mobile portion 1305 may be decoupled from the torque tube 1330 to fully transition the table to the mobile transport. In this example, a first wall of the support device 1340 and is rotated away 1350 from the tube 1330. A second wall of the support device 1340 is also rotated away 1360 from the torque tube 1330 allowing the mobile portion to be decoupled from the solar table 1320. Thereafter, the solar table 1320 is fully supported by the mobile transport.

One skilled in the art will recognize that a variety of support devices and solar table decoupling procedures are enabled by embodiments of the invention. Additionally, the mobile transport may comprise verification elements that confirm that a solar table is properly secured for transportation.

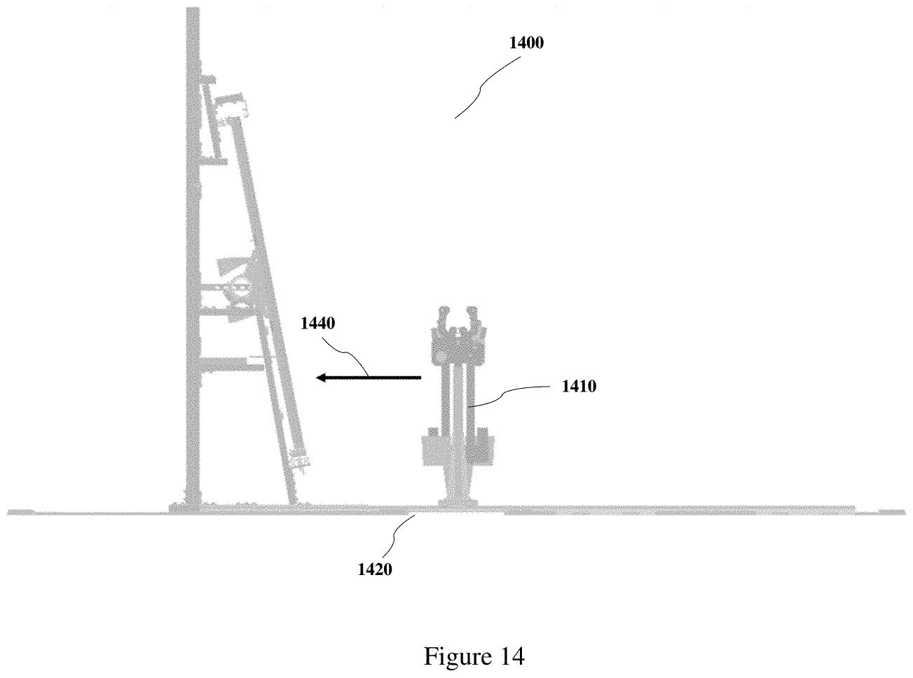

FIG. 14 illustrates a fourth step in a method of transitioning an assembled solar table from an assembly unit to a mobile transport according to various embodiments of the invention. After the solar table is secured to the mobile transport, the solar table may be transported to an installation point. This transportation may be performed by an individual, automated driving process or combination thereof. The mobile portion 1410 may be positioned back 1440 within the assembly unit 1400 via track 1420. In certain embodiments, the mobile portion 1410 may be moved back after a solar table has been completely or partially assembled within the assembly unit 1400. In other embodiments, the mobile portion 1410 is moved back prior to an assembly process of the solar table.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A solar table assembly unit (hereinafter, “assembly unit”) for assembling a solar table in a location remote from an installation point within a solar system, the assembly unit comprising:
at least one vertical support structure that extends vertically from a base;
a central support structure coupled to the at least one vertical support structure, the central transport structure supports a torque tube having a plurality of coupling points;
an upper rail coupled to the at least one vertical support structure, the upper rail supports a first portion of a solar component of the solar table; and
a lower rail coupled to the at least one vertical support structure, the lower rail supports a second portion of a solar component of the solar table; and
wherein the upper rail and lower rail facilitate horizontal movement of the solar component relative to at least one coupling point within the plurality of coupling points, the at least one coupling point providing an attachment between the solar component and the torque tube.

2. The assembly unit of claim 1 wherein the solar component is a solar panel.

3. The assembly unit of claim 1 further comprising a mobile portion that supports an assembled solar table and moves the assembled solar table from the assembly unit to a mobile transport.

4. The assembly unit of claim 3 wherein movement of the mobile portion occurs via a track between the assembly unit and the mobile transport.

5. The assembly unit of claim 1 further comprising a safety latch that secures a solar component within the assembly unit.

6. The assembly unit of claim 5 wherein the safety latch secures the solar component within a vertical plane.

7. The assembly unit of claim 6 wherein the safety latch secures the solar component within a horizontal plane.

8. The assembly unit of claim 5 wherein the safety latch comprises at least one edge extender that extends over a solar component within the assembly unit.

9. The assembly unit of claim 1 wherein the central support structure comprises an angled surface and a support element, the angled surface and support element support the torque tube within the assembly unit.

10. The assembly unit of claim 1 wherein the central support structure comprises a C-shaped holder that supports the torque tube within the assembly unit

11. The assembly unit of claim 1 wherein the upper and lower rails comprise movement elements that facilitate horizontal movement of one or more solar components within the assembly unit and relative to at least one coupling point within the plurality of coupling points.

12. The assembly unit of claim 11 wherein the movement elements are selected from wheels or rotational balls.

13. The assembly unit of claim 1 wherein the solar table is assembled using at least one automated process.

14. A method for assembling a solar table in a location remote to an installation point within a solar system, the method comprising:
placing a torque tube within a central support structure of an assembly unit that is in a location remote from an installation point;
securing at least one solar component to the torque tube by horizontally moving the at least one solar component along an upper rail and a lower rail within the assembly unit, the at least one solar component being secured to the torque tube using at least one coupling point;
decoupling an assembled solar table from the assembly unit, the assembled solar table comprising the torque tube and the at least one solar component; and
placing the assembled solar table on a mobile transport via a mobile portion of the assembly unit.

15. The method of claim 14 wherein the mobile portion moves along a track between the assembly unit and the mobile transport.

16. The method of claim 14 wherein the mobile portion comprises a support device that supports the solar table during movement between the assembly unit and the mobile transport.

17. The method of claim 16 wherein the mobile transport comprises a solar table holder that secures the assembled solar table to the mobile transport.

18. The method of claim 17 further comprising the step of aligning the support device on the mobile portion to the solar table holder to facilitate transition of the assembled solar table from the mobile portion to the mobile transport.

19. The method of claim 14 wherein the step of decoupling the assembled solar table from the assembly unit comprises rotating a safety latch away from the assembled solar table.

20. The method of claim 14 wherein the at least one solar component horizontally moves along an upper rail and a lower rail is facilitated by a plurality of movement elements within the upper and lower rails.
